(19) United States
(12) Patent Application Publication
(10) Pub. No.: US 2004/0255038 A1
(43) Pub. Date: Dec. 16, 2004

(54) Electronic apparatus, server apparatus, network system, and control method for network system

(75) Inventors: Kazuyo Kuroda, Tokyo (JP); Takero Kobayashi, Akishima-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHUKI KAISHA TOSHIBA

(21) Appl. No.: 10/805,329

(22) Filed: Mar. 22, 2004

(30) Foreign Application Priority Data
Apr. 24, 2003 (JP) 2003-120094

(51) Int. Cl. G06F 15/16

(52) U.S. Cl. 709/229

(57) ABSTRACT

A ROM stores a device name table which holds a plurality of names each including an expression that allows to recognize the installation location of a device and a device unique ID that allows to identify the device. In response to a user request, a control device displays, as a list of choices on a display device, the plurality of names held by the device name table. When a name is selected, the control device makes the name correspond to the device unique ID and stores them in the name management table of a RAM and transmits the name management table to a server connected through a home network.

### CROSS-REFERENCE TO RELATED APPLICATIONS

This application is based upon and claims the benefit of priority from prior Japanese Patent Application No. 2003-120094, filed Apr. 24, 2003, the entire contents of which are incorporated herein by reference.

### BACKGROUND OF THE INVENTION

1. Field of the Invention

The present invention relates to an electronic apparatus, server apparatus, network system, and a control method for the network system which can increase the convenience in operating electronic apparatus such as a TV apparatus and air conditioner connected to, e.g., a local area network (LAN) constructed indoors by remote control from the outdoors through the Internet.

2. Description of the Related Art

Along with recent improvements in information communication technology and information processing technology, home networks that connect household appliances installed in rooms have started coming into widespread use. In a home network, generally, a computer called a home server collectively manages all household appliances.

A home server has a function of registering unique information such as an IP address of each household appliance connected to a home network. The home server executes collective management of the household appliances on the basis of the registered unique information. Various methods have therefore been invented to efficiently register the unique information of household appliances in a home server (e.g., Jpn. Pat. Appln. KOKAI Publication No. 2002-91839).

Assume that household appliances connected to a home network are operated by remote control from the outdoors by using a cellular phone. Assume that a plurality of video recorders, which are installed in different rooms to record/play back TV broadcasting, are connected to the home network. Assume that the user should designate recording programming to one of the plurality of video recorders.

In such a case, i.e., when a plurality of household appliances of the same type are present in a house, the user must do a cumbersome operation to, e.g., register, in a home server in advance, names that can easily recognize the respective devices to specify a desired device.

The network management system described in Jpn. Pat. Appln. KOKAI Publication No. 2002-91839 described above has no regard for easily identifying each of a plurality of terminals of the same type.

### BRIEF SUMMARY OF THE INVENTION

According to an embodiment of the present invention, a electronic apparatus connected to a server apparatus through a network, comprises a storage unit which stores a table which holds a plurality of names, a selection unit configured to select one of the plurality of names held by the table stored in the storage unit, and a transmission unit configured to transmit, to the server apparatus, device information that makes the name selected by the selection unit correspond to identification information that allows to identify the electronic apparatus.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a view showing the configuration of a network system according to an embodiment of the present invention;

FIG. 2 is a block diagram showing the schematic arrangement of a server according to the embodiment;

FIG. 3 is a block diagram showing the schematic arrangement of a TV apparatus connected to a home network according to the embodiment;

FIG. 4 is a view showing an example of a device name table held in the TV apparatus according to the embodiment;

FIG. 5 is a view showing an example of a device selection window displayed on the TV apparatus according to the embodiment;

FIG. 6 is a view showing an example of a name management table held in the TV apparatus according to the embodiment;

FIG. 7 is a view showing an example of a device management table held in the server according to the embodiment;

FIG. 8 is a view showing an access structure on the road in the network system according to the embodiment;

FIG. 9 is a view showing a higher-level server management table held by the server B shown in FIG. 8;

FIG. 10 is a view showing a lower-level server management table held by the server B shown in FIG. 8;

FIG. 11 is a view showing a higher-level server management table held by the server E shown in FIG. 8;

FIG. 12 is a view showing a lower-level server management table held by the server E shown in FIG. 8;

FIG. 13 is a view showing a control device selection window presented to the user by the server E shown in FIG. 8;

FIG. 14 is a view showing a device control window presented to the user by the server E shown in FIG. 8;

FIG. 15 is a first flow chart showing the operation procedures of the server and household appliances in the home network according to the embodiment;

FIG. 16 is a second flow chart showing the operation procedures of the server and household appliances in the home network according to the embodiment;

FIG. 17 is a third flow chart showing the operation procedures of the server and household appliances in the home network according to the embodiment;

FIG. 18 is a view showing the schematic arrangement of an air conditioner having a name registration dial according to the embodiment; and

FIG. 19 is a block diagram showing an example of the arrangement of a selection device prepared in the air conditioner.

### DETAILED DESCRIPTION OF THE INVENTION

An embodiment of the present invention will be described below with reference to the accompanying drawing.

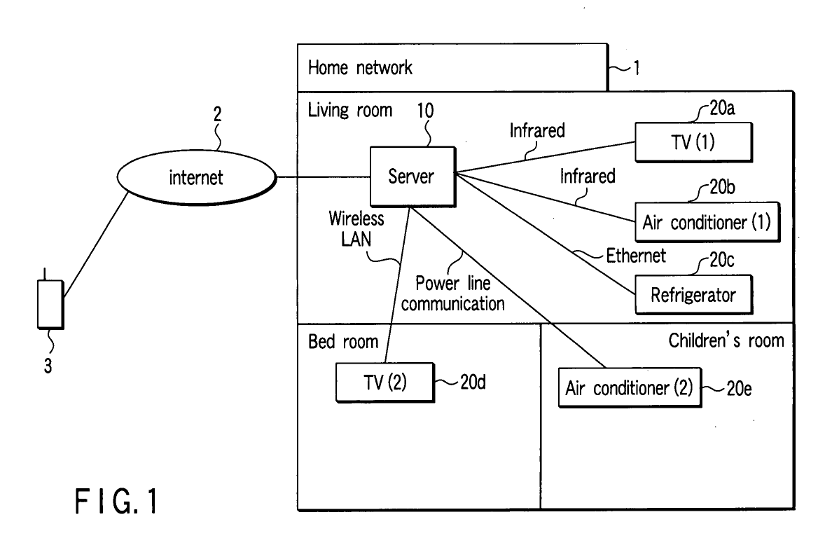

FIG. 1 is a view showing the configuration of a network system according to the embodiment of the present invention.

As shown in FIG. 1, this network system is a home network 1 that connects household appliances (TV apparatuses (to be referred to as TVs hereinafter), air conditioners, and a refrigerator) installed in rooms (living room, bed room, and children's room) in a house. The home network 1 is connected to Internet 2 through a server 10 to collectively manage the household appliances. The server 10 has an interface function of receiving operation instructions for the household appliances installed in the rooms through the Internet 2. With this function, the user can operate a desired household appliance on the road by using, e.g., a cellular phone 3.

In the example shown in FIG. 1, there are three rooms, i.e., a living room, a bed room, and a children's room. A TV (1) 20a, air conditioner (1) 20b, and refrigerator 20c are installed in the living room in addition to the server 10. A TV (2) 20d is installed in the bed room. An air conditioner (2) 20e is installed in the children's room. The server 10 is connected to TV (1) 20a and air conditioner (1) 20b by infrared communication using an IrDA system. The server 10 and refrigerator 20c are connected by wired LAN communication using an Ethernet (R) system. The server 10 and TV (2) 20d are connected by wireless LAN communication using, e.g., an IEEE 802.11b system. The server 10 and air conditioner (2) 20e are connected by power line communication.

That is, in this home network 1, a plurality of household appliances of the same type are present, like the TV (1) 20a and TV (2) 20d, and the air conditioner (1) 20b and air conditioner (2) 20e. As a characteristic feature of the home network 1, configuration setup can efficiently be executed. Hence, the user who wants to operate, e.g., the TV (1) 20a on the road by using the cellular phone 3 can easily select the operation target without selecting by mistake the TV (2) 20d as a household appliance of the same type. This characteristic feature will be described below in detail.

In this example, infrared communication using an IrDA system, wired LAN communication using an Ethernet (R) system, power line communication, and wireless LAN communication using an IEEE 802.11b system are performed. These communication methods are merely examples. For example, communication using any other communication means such as radio communication using, e.g., a Bluetooth (R) system or wired communication using an IEEE 1394 system may be performed.

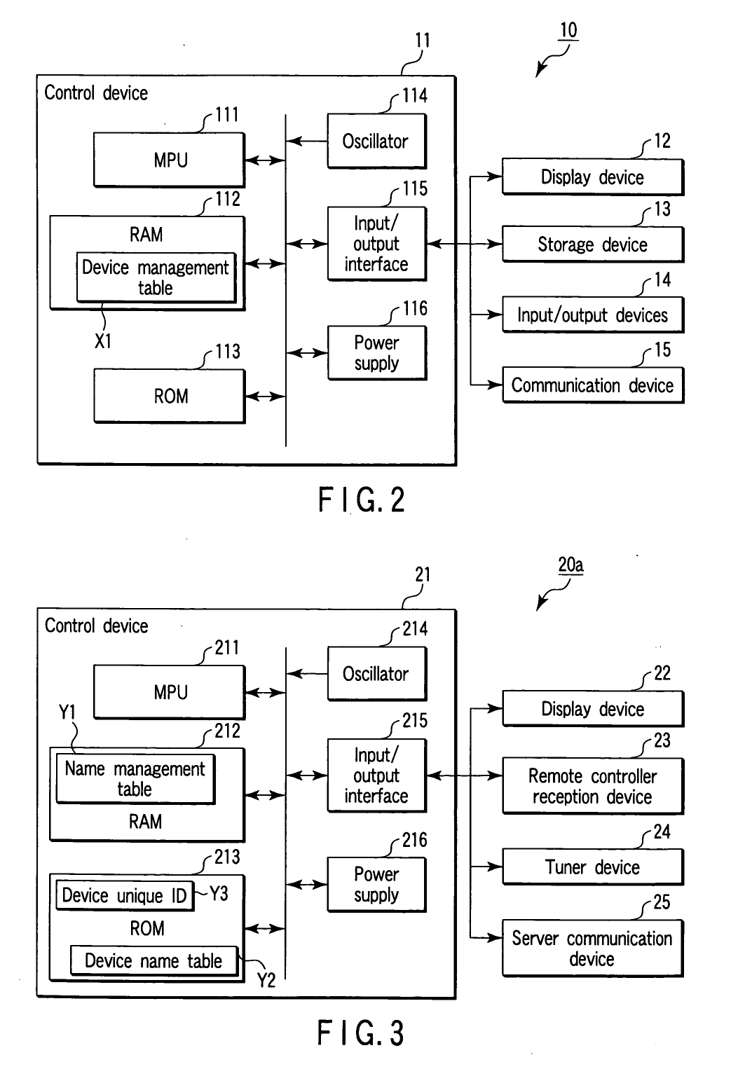

FIG. 2 is a block diagram showing the schematic arrangement of the server 10.

As shown in FIG. 2, the server 10 comprises a control device 11, display device 12, storage device 13, input/output devices 14, and communication device 15.

The control device 11 is a device that controls the entire server 10. The control device 11 has an MPU 111, RAM 112, ROM 113, oscillator 114, input/output interface 115, and power supply 116.

The MPU 111 executes and controls various kinds of programs stored in the RAM 112 and ROM 113. The RAM 112 and ROM 113 store various kinds of programs executed and controlled by the MPU 111 and various kinds of data used by these programs. The RAM 112 is a volatile storage medium and stores various data as a work area of the MPU 111. A device management table X1 (to be described later) is stored in the RAM 112. On the other hand, the ROM 113 is a nonvolatile storage medium and stores fundamental programs and fundamental data for system control.

The oscillator 114 manages the system time and generates a sync signal. The input/output interface 115 transmits/receives data to/from the display device 12, storage device 13, input/output devices 14, and communication device 15. The power supply 116 supplies and controls operation power to each section.

The display device 12 displays image data created by a program executed and controlled by the MPU 111. The storage device 13 is a volatile storage medium which stores various kinds of programs and various kinds of data in an enormous quantity as an auxiliary storage of the RAM 112. The input/output devices 14 are various kinds of devices such as a keyboard controller and DVD apparatus, which execute data exchange with the user. The communication device 15 has an Ethernet communication function, infrared communication function, wireless LAN communication function, and power line communication function. The communication device 15 executes and controls all communications of the server 10, including data transmission/reception through the Internet 2 and data transmission/reception to/from the household appliances in the home network 1.

FIG. 3 shows the schematic arrangement of the TV (1) 20a. Although the arrangement of the TV (1) 20a will be described here, the other TV (2) 20d also has the same arrangement as that of the TV (1) 20a. Even in the remaining household appliances, the main part has almost the same arrangement as that of the TV (1) 20a.

As shown in FIG. 3, the TV (1) 20a comprises a control device 21, display device 22, remote controller reception device 23, tuner device 24, and server communication device 25.

The control device 21 is a device that controls the entire TV (1) 20a. The control device 21 has an MPU 211, RAM 212, ROM 213, oscillator 214, input/output interface 215, and power supply 216.

The MPU 211 executes and controls various kinds of programs stored in the RAM 212 and ROM 213. The RAM 212 and ROM 213 store various kinds of programs executed and controlled by the MPU 211 and various kinds of data used by these programs. The RAM 212 is a volatile storage medium and stores various data as a work area of the MPU 211. A name management table Y1 (to be described later) is stored in the RAM 212. On the other hand, the ROM 213 is a nonvolatile storage medium and stores fundamental programs and fundamental data for system control. A device name table Y2 and device unique ID Y3 (to be described later) are stored in the ROM 213.

The oscillator 214 manages the system time and generates a sync signal. The input/output interface 215 transmits/receives data to/from the display device 22, remote controller reception device 23, tuner device 24, and server communication device 25. The power supply 216 supplies and controls operation power to each section.

The display device 22 displays TV broadcast data received by the tuner device 24. The remote controller reception device 23 receives user operation information transmitted from a remote controller (not shown) by infrared communication and transfers the operation information to the control device 21. The tuner device 24 receives TV broadcast data of a channel desired by the user and outputs a video signal and audio signal. The server communication device 25 has an infrared communication function and executes and controls data transmission/reception to/from the server 10.

In relation to the server 10 and TV (1) 20a in the home network 1, which have the above-described arrangements, the principle of an operation of registering the TV (1) 20a in the server 10 will be described next.

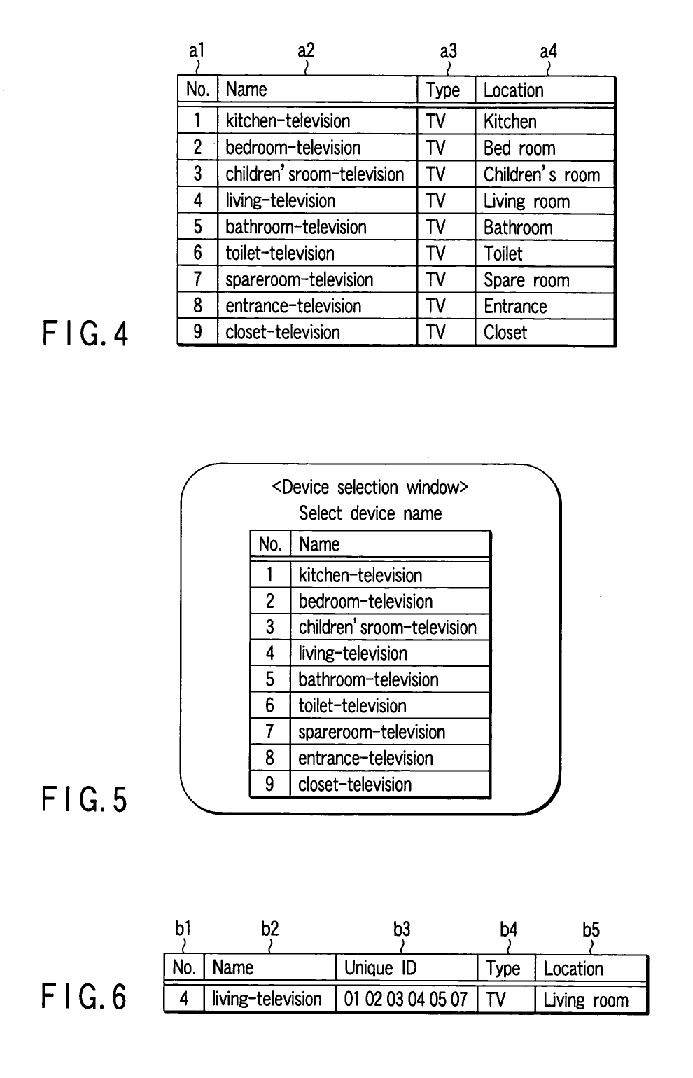

FIG. 4 is a view showing an example of the device name table Y2 that the TV (1) 20a stores in the ROM 213 of the control device 21. As shown in FIG. 4, the device name table Y2 holds a management number a1, name a2, type a3, and location a4.

At the TV (1) 20a is newly bought, When operation information for registration in the server 10 is transmitted from the remote controller, the remote controller reception device 23 of the TV (1) 20a receives the operation information and transmits it to the control device 21. The control device 21 that has received the operation information displays, on the display device 22, a window in which the management number a1 and name a2 held in the device name table Y2 are presented as choices. FIG. 5 is a view showing an example of the device selection window displayed on the display device 22 at this time.

As shown in FIG. 5, the name a2 displayed in the device selection window contains various expressions that allow to recognize installation locations. The TV (1) 20a is installed in the living room. Hence, the user selects “No. 4” of the management number a1, which corresponds to “living-television”. Then, the control device 21 acquires data corresponding to “No. 4” of the management number a1 from the device name table Y2 and also reads out the device unique ID Y3 stored in the ROM 213. The control device 21 stores the two data in the name management table Y1 in the RAM 212 in correspondence with each other. FIG. 6 is a view showing an example of the name management table Y1 stored in the RAM 212. As shown in FIG. 6, the name management table Y1 is formed from a management number b1, name b2, unique ID b3, type b4, and location b5.

The value of the device unique ID Y3 stored in the ROM 213 is “01 02 03 04 05 07”. This value is stored in the unique ID b3 of the name management table Y1. The values of the management number b1, name b2, type b4, and location b5 correspond to the management number a1, name a2, type a3, and location a4 of the device name table Y2, respectively.

The control device 21 notifies the server 10 of the name management table Y1 through the server communication device 25. Registration processing in the server 10 is thus ended.

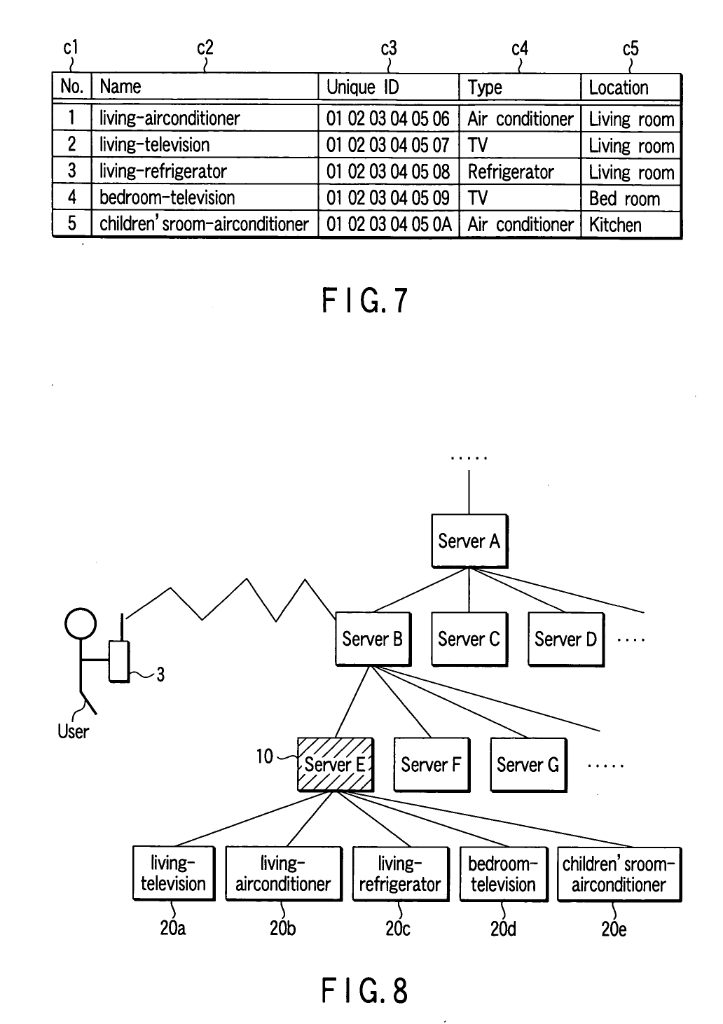

On the other hand, upon receiving the notification, the control device 11 of the server 10 stores the contents of the notification in the device management table X1 in the RAM 112. FIG. 7 is a view showing an example of the device management table X1 stored in the RAM 112. As shown in FIG. 7, the device management table X1 is formed from a management number c1, name c2, unique ID c3, type c4, and location c5. In this example, in the name management table Y1 sent from the TV (1) 20a, the management number c1 is stored in the second row.

The control device 11 of the server 10 requests notification of the name management table Y1 of all household appliances connected to the home network 1 every, e.g., 3 hrs. The control device 11 compares the contents of a notification returned in response to the request with the contents stored in the device management table X1 in the RAM 112. If the contents do not coincide with each other, the device management table X1 is updated by applying the current notification contents. If no notification is returned in response to the request, the control device 11 determines that the household appliance is disconnected from the home network 1 and deletes corresponding data in the device management table X1. For updating of the device management table X1, the household appliance side may request the server 10 to execute the update processing when some change has occurred.

As described above, the home network 1 provides a mechanism to the user, in which each of the household appliances has the device name table Y2 that holds the plurality of names a2 including expressions that allow to recognize installation locations. Only by selecting one of the names, a corresponding household appliance can be registered in the server 10.

The principle of the operation of the server 10 when the household appliances of the home network 1, for which configuration setup has been done in the above-described manner, is to be operated by remote control will be described next.

FIG. 8 is a view showing an access structure on the road. Assume that the server 10 shown in FIG. 1 corresponds to a server E. Assume that the server of the cellular phone 3 corresponds to a server B.

The servers are connected through the Internet based on the TCP/IP protocol. Each server holds a unique IP address and host name. A database that makes host names correspond to IP addresses is managed for each organization. Organizations build a hierarchical structure. Each server holds a unique name called a domain name with a hierarchical structure and is managed by a higher-level server.

The server B manages a domain name “serverB.serverA.co.jp” and manages the servers E, F, and G connected to the lower level. The server B also serves as a cellular phone gateway that converts data into data compatible with the Internet when accessed from the cellular phone 3 or converts data from the Internet into data compatible with the cellular phone 3. A server A manages a domain name “serverA.co.jp” and manages the servers B, C, and D connected to the lower level. In a similar way, higher-level servers and lower-level servers form a hierarchical structure.

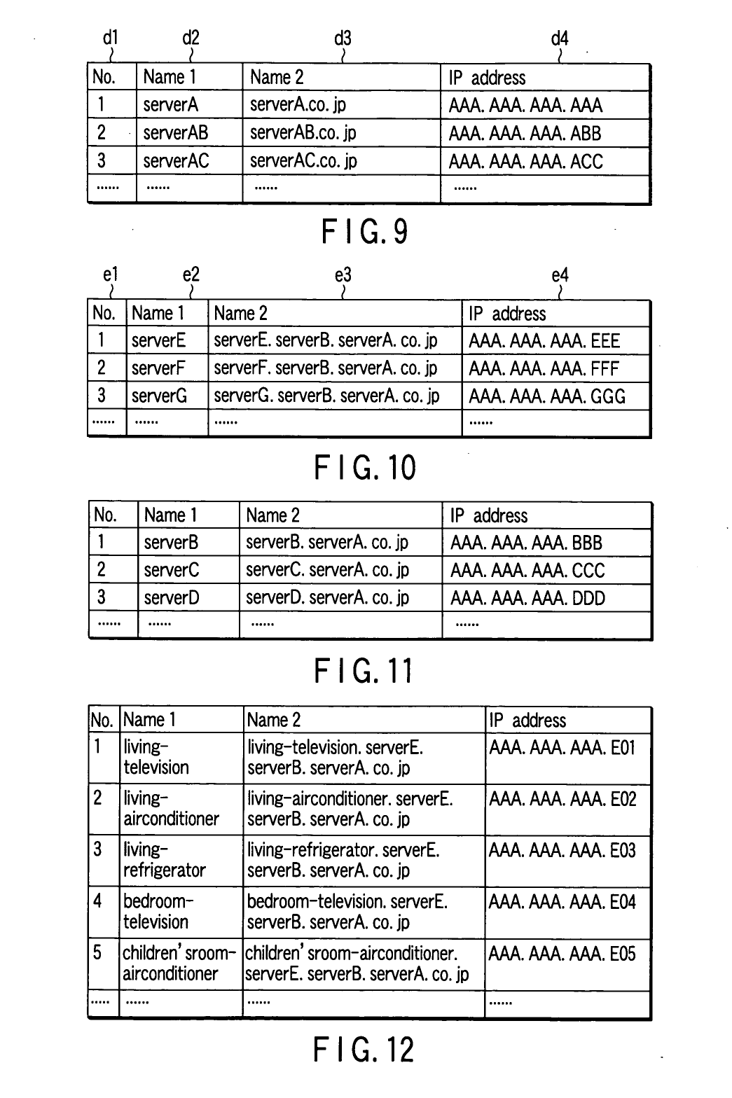

FIG. 9 is a view showing a higher-level server management table held by the server B. The higher-level server management table is formed from a management number d1, name 1 d2, name 2 d3, and IP address d4. FIG. 10 is a view showing a lower-level server management table held by the server B. The lower-level server management table is also formed from a management number e1, name 1 e2, name 2 e3, and IP address e4.

FIGS. 11 and 12 are views showing higher-level server and lower-level server management tables held by the server E.

Assume that the user is going to operate, on the road, the air conditioner (1) 20b installed in the living room of his/her home. In this case, the user first inquires the server B of the cellular phone 3 about using a name “serverE.serverB.serverA.co.jp”. The server B refers to the items of the name 2 e3 in the lower-level server management table held by itself. If a name that coincides with the above name is present, the server B returns the name 1 e2 and IP address e4. If no name coincides with the above name, the server B looks up the higher-level server management table and inquires the server of management number 1 about the name “serverE.serverB.serverA.co.jp”. If a name that coincides with the above name is present in the name 2 e3 of the lower-level server management table held by the higher-level server, the server B returns the name 1 e2 and IP address e4. If no name coincides with the above name, the server B inquires the server to which management number 1 is assigned in the higher-level server management table of the server about the name. The inquiry to the higher-level server is repeated. If no name coincides with the above name even in the highest-level server, a replay “Unknown server” is returned, and the processing is ended.

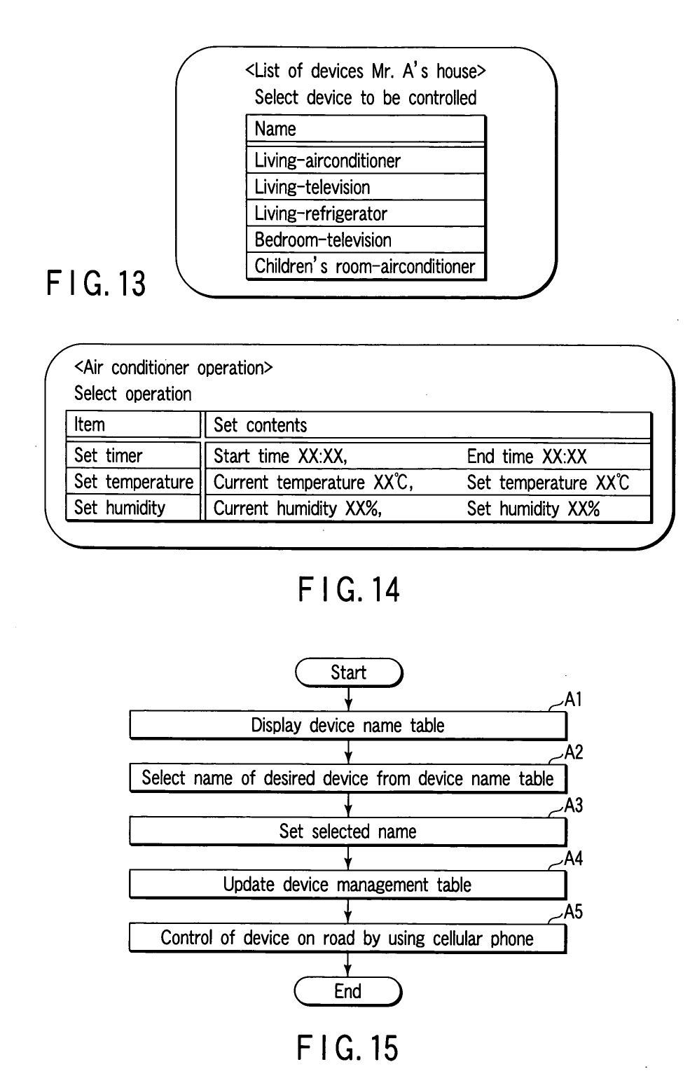

The user can know from the lower-level server management table of the server B that the IP address of the host having the name “serverE.serverB.serverA.co.jp” is “AAA.AAA.AAA.EEE”. The user inquires of the IP address about the device managed by the server E. The server E looks up the device management table X1, extracts the items of the name c2, and presents the control device selection window shown in FIG. 13 to the user.

When the user selects a device to be controlled, the server E refers to the management number c1 of the device management table X1 and the items of the management number e1 of the lower-level server management table and specifies that a device corresponding to the management numbers is the selected device. The domain name and IP address of the selected device are the name 2 e3 and IP address e4 corresponding to the management number e1 of the lower-level server management table. Subsequently, the server E inquires of the specified device about the function that the device holds by using the IP address. Upon receiving the inquiry, the device returns the function that the device holds and a control method therefor to the server E. On the basis of the information, the server E presents the device control window shown in FIG. 14 to the user. When the user sets necessary functions in the window, the server E controls the device on the basis of the specified IP address.

As described above, in the home network 1, when the user wants to operate a household appliance on the road, names containing expressions that allow to recognize installation locations are displayed as a list of choices. Even when there are a plurality of household appliances of the same type, the user can easily select a desired household appliance.

The server 10 is connected to the Internet 2. However, the server 10 may be connected to any other network such as a dedicated line. That is, although the server 10 communicates with other server devices by using the TCP/IP protocol, communication using another protocol such as UDP may be executed.

The server 10 uses a domain name to manage a host name and IP address. However, any other management method may be used. The server 10 manages a host name and IP address in correspondence with each other. Instead of using the IP address, a unique ID may be assigned to each device to manage it, and the unique ID and device name may be managed in correspondence with each other.

FIGS. 15 to 17 are flow charts showing the operation procedures of the server 10 and household appliances in the home network 1.

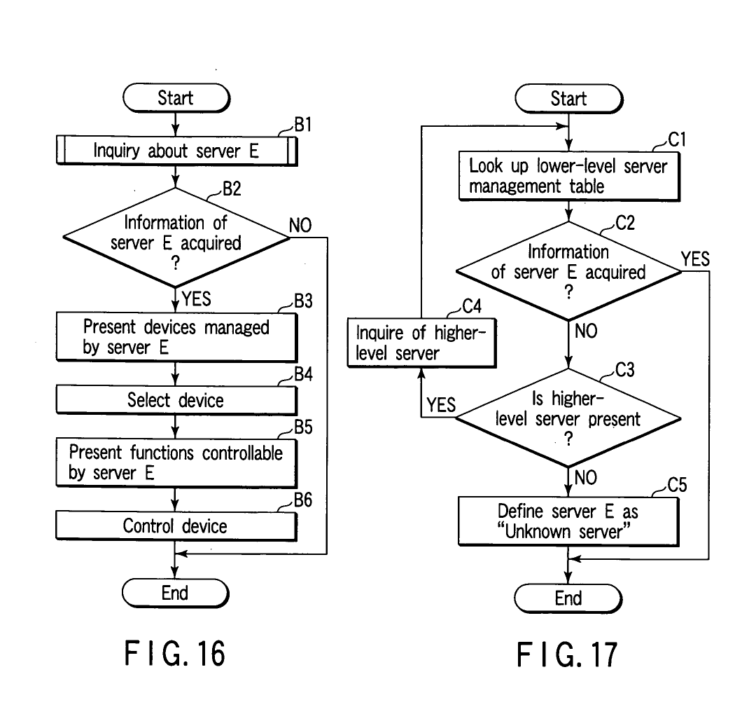

To register a household appliance in the server 10, the household appliance is caused to display a device selection window first (step A1 in FIG. 15). The device selection window displays, as a list of choices, a plurality of names containing expressions that allow to recognize installation locations, which are held in the device name tables Y2 prepared in the household appliances. The user selects the most appropriate name in this window (step A2 in FIG. 15). When this selection is done, the household appliance stores, in the name management table Y1, the data in the device name table Y2 corresponding to the name together with the value of the device unique ID Y3 (step A3 in FIG. 15). On the other hand, the server 10 acquires the name management table Y1 of each household appliance periodically or as needed. On the basis of the name management table Y1, the server 10 updates the device management table X1 to represent the latest state of the home network 1 (step A4 in FIG. 15). On the basis of the device management table X1, remote control of each household appliance by using the cellular phone 3 is controlled (step A5 in FIG. 15). FIG. 16 shows details of step A5 in FIG. 15.

The user who uses the cellular phone 3 first inquires of the server B, i.e., the server of the cellular phone 3 about the server E (step B1 in FIG. 16). FIG. 17 shows details of step B1 in FIG. 16. Upon receiving the inquiry, the server B looks up the lower-level server management table held by itself (step C1 in FIG. 17) to try to acquire the information of the server E. If the information of the server E is acquired (YES in step C2 in FIG. 17), the processing is ended. On the other hand, if the information of the server E is not acquired (NO in step C2 in FIG. 17), it is checked whether or not a higher-level server is present (step C3 in FIG. 17). If a higher-level server is present (YES in step C3 in FIG. 17), the higher-level server is inquired about the server E (step C4 in FIG. 17). Upon receiving the inquiry, the higher-level server repeats the processing from step C1 in FIG. 17.

This processing is repeated until the information of the server E is acquired. Even the server of highest level cannot acquire the information of the server E (NO in step C3 in FIG. 17), the server E is defined as “Unknown server” (step C5 in FIG. 17), and the processing is ended.

When the information of the server E is acquired (YES in step B2 in FIG. 16), the server with the IP address contained in the information is inquired about managed devices. Upon receiving this inquiry, the server E transmits window data to display the list of the managed devices on the cellular phone 3 (step B3 in FIG. 16). The user selects a desired device in the displayed window (step B4 in FIG. 16). When the selection is done, the server 10 transmits window data to display, on the cellular phone 3, the list of functions controllable for the selected device (step B5 in FIG. 16). The user selects a desired function in the displayed window. In accordance with the selection, the server 10 executes control of the device (step B6 in FIG. 16).

As described above, the home network 1 implements efficient configuration setup to easily identify a plurality of household appliances connected to the home network 1.

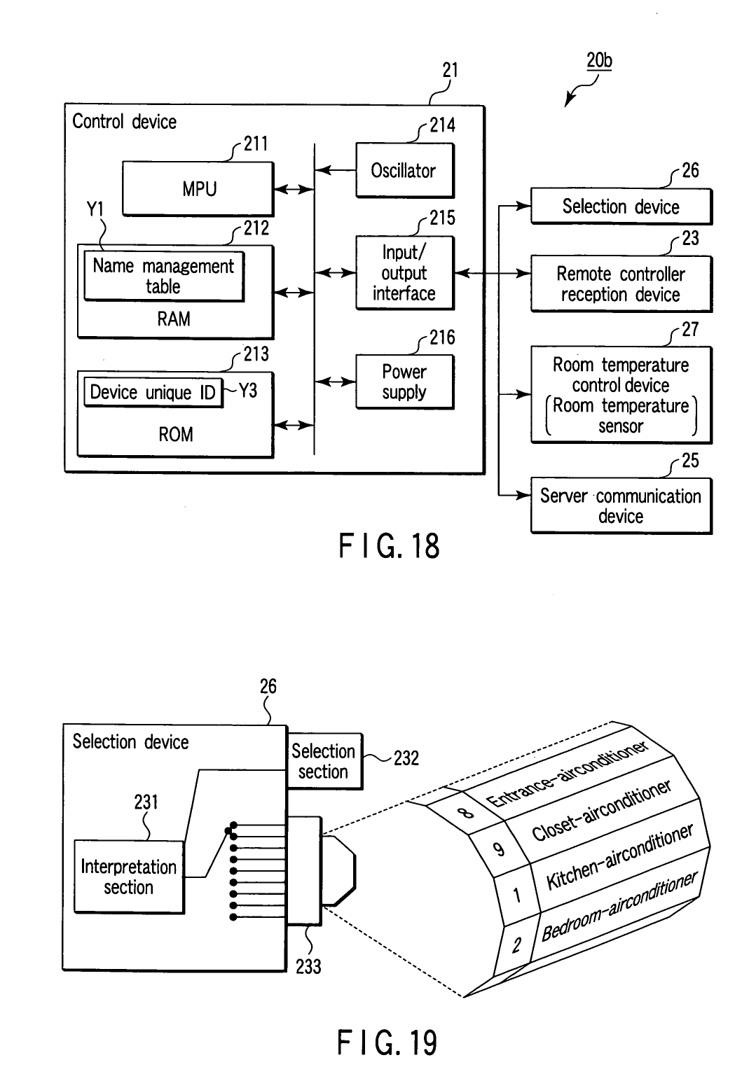

In the above-described embodiment, the names a2 of the device name table Y2 stored in the ROM 213 are displayed on the display device 22 as choices to register the name of a household appliance in the server 10. In a household appliance which does not have the display device 22, registration may be done by operating a dial with names prepared as choices. FIG. 18 shows the schematic arrangement of the air conditioner (1) 20b having a name registration dial.

As shown in FIG. 18, the air conditioner (1) 20b has no display device, unlike the above-described TV (1) 20a. Instead, the air conditioner (1) 20b has a selection device 26 that the TV (1) 20a does not have (the air conditioner (1) 20b also has a room temperature control device 27 in place of the tuner device 24). FIG. 19 is a block diagram showing an example of the arrangement of the selection device 26. The selection device 26 is constituted by an operation section 232, dial section 233, and interpretation section 231. The operation section 232 executes a decision operation. The dial section 233 rotates a dial on which management numbers and names are printed to select one of them. The interpretation section 231 interprets the selection result by the dial section 233 and notifies the control device 21 of it.

Since the air conditioner (1) 20b is installed in the living room, the user rotates the dial section 233 until the name “living-airconditioner” comes to the front. When the name comes to the front, the user operates the operation section 232. Accordingly, the user can register “living-airconditioner” as the name of the air conditioner (1) 20b in the server 10. In addition to the dial, a touch panel, voice input, image input, character input, and any other means can be used for selection by the selection device 26.

In the above-described embodiment, the device name table Y2 is stored in the ROM 213. However, the device name table Y2 may be stored in the RAM 212 or any other storage area. The device name table Y2 may be stored not in a storage medium such as the ROM 213 on the household appliance side but in a storage area of the ROM 113 on the side of the server 10. The device name table Y2 may be provided to the household appliance side when a request is received from there.

In the above-described embodiment, names including expressions that allow to specify locations in a house have been exemplified. The expressions may be able to specify locations in an office, a station yard, or the like. The expressions may be able to specify not only installation locations but also devices. Alternatively, the expressions may be able to specify devices and their performances so that, e.g., a DVD player having a timer function can be specified. The expressions may be able to specify device maker names such as company A or B or the names of companies that have purchased the devices, such as company C or D. The expressions may be able to specify product information such as article names, models, or popular names or times such as dates of manufacture or dates of purchase. The expressions may be able to specify users such as a grandfather, grandmother, father, mother, older or younger sister, older or younger brother, or grandchild. In this case, the names may be changed to the actual names of the users.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic apparatus connected to a server apparatus through a network, comprising:
a storage unit which stores a table which holds a plurality of names;
a selection unit configured to select one of the plurality of names held by the table stored in the storage unit; and
a transmission unit configured to transmit, to the server apparatus, apparatus information that makes the name selected by the selection unit correspond to identification information that allows to identify the electronic apparatus.

2. The electronic apparatus according to claim 1, further comprising:
a display unit, and
a list display unit configured to display, as a list of choices on the display unit, the plurality of names held by the table stored in the storage unit, and
the selection unit selects one of the plurality of names displayed as a list by the list display unit.

3. The electronic apparatus according to claim 1, further comprising an operation unit which can set one of a plurality of states, and
the selection unit interprets the state set by the operation unit and selects a name corresponding to the state from the plurality of names.

4. The electronic apparatus according to claim 1, wherein the table stored in the storage unit holds names each including an expression that allows to recognize an installation location of the electronic apparatus.

5. The electronic apparatus according to claim 1, wherein the table stored in the storage unit holds names each including an expression that allows to recognize a user of the electronic apparatus.

6. The electronic apparatus according to claim 1, wherein the table stored in the storage unit holds names each including an expression that allows to recognize product information of the electronic apparatus.

7. A server apparatus connected to a plurality of electronic apparatuses through a network, comprising:
a management unit configured to acquire, from each of the plurality of electronic apparatuses, apparatus information containing a name of the electronic apparatus and identification information that allows to identify the electronic apparatus, and manage the apparatus information;
a return unit configured to return, to another electronic apparatus which remote-controls the plurality of electronic apparatuses, the name and identification information contained in the apparatus information managed by the management unit as information to specify a current operation target; and
a control unit configured to receive, from the another electronic apparatus, a remote control request to which the identification information returned by the return unit is added, and transmit, through the network, a control signal corresponding to the remote control request to an electronic apparatus identified by the identification information.

8. A network system in which a plurality of electronic apparatuses are connected to a server apparatus through a network, wherein
each of the plurality of electronic apparatuses comprising:
a storage unit which stores a table which holds a plurality of names;
a selection unit configured to select one of the plurality of names held by the table stored in the storage unit; and
a transmission unit configured to transmit, to the server apparatus, apparatus information that makes the name selected by the selection unit correspond to identification information that allows to identify the electronic apparatus, and
the server apparatus comprising:
a management unit configured to acquire, from each of the plurality of electronic apparatus, apparatus information containing the name and identification information, and manage the apparatus information;
a return unit configured to return, to another electronic apparatus which remote-controls the plurality of electronic apparatuses, the name and identification information contained in the apparatus information managed by the management unit as information to specify a current operation target; and
a control unit configured to receive, from the another electronic apparatus, a remote control request to which the identification information returned by the return unit is added, and transmit, through the network, a control signal corresponding to the remote control request to an electronic apparatus identified by the identification information.

9. The network system according to claim 8, wherein the table stored in the storage unit holds names each including an expression that allows to recognize an installation location of the electronic apparatus.

10. The network system according to claim 8, wherein the table stored in the storage unit holds names each including an expression that allows to recognize a user of the electronic apparatus.

11. The network system according to claim 8, wherein the table stored in the storage unit holds names each including an expression that allows to recognize product information of the electronic apparatus.

12. A control method for a network system in which a plurality of electronic apparatuses are connected to a server apparatus through a network, wherein
each of the plurality of electronic apparatus comprising:
selecting one of a plurality of names given as choices in advance, and
transmitting, to the server apparatus, apparatus information that makes the selected name correspond to identification information that allows to identify the electronic apparatus, and
the server apparatus comprising:
acquiring the apparatus information from each of the plurality of electronic apparatuses and managing the apparatus information,
returning, to another electronic apparatus which remote-controls the plurality of electronic apparatuses, the name and identification information contained in the managed apparatus information as information to specify a current operation target, and
receiving, from the another electronic apparatus, a remote control request to which the returned identification information is added, and transmitting, through the network, a control signal corresponding to the remote control request to an electronic apparatus identified by the identification information.
